(19) United States
(12) Patent Application Publication
(10) Pub. No.: US 2015/0022395 A1
(43) Pub. Date: Jan. 22, 2015

(54) METHOD AND RECEIVER FOR DETERMINING SYSTEM TIME OF A NAVIGATION SYSTEM

(71) Applicant: O2Micro Inc., Santa Clara, CA (US)

(72) Inventors: Juan Gou, Chengdu (CN); Jinghua Zou, Chengdu (CN); Weihua Zhang, Chengdu (CN)

(21) Appl. No.: 14/331,389

(22) Filed: Jul. 15, 2014

(30) Foreign Application Priority Data
Jul. 16, 2013 (CN) 201310297717.2

(51) Int. Cl. G01S 19/13

(52) U.S. Cl. CPC G01S 19/13
USPC 342/357.51

(57) ABSTRACT

Receiver and methods for determining system time of a navigation system is disclosed. In one example, the receiver includes a baseband processing module and a calculation module. The baseband processing module is configured for obtaining satellite information from the navigation system. The calculation module is configured for estimating a pseudorange based on the satellite information; smoothing the pseudorange via a code; calculating clock bias and clock drift based on the smoothed pseudorange; and determining system time of the navigation system based on the calculated clock bias and clock drift.

### RELATED APPLICATIONS

This application claims priority to the benefit of Chinese Patent Application Number 201310297717.2, filed on Jul. 16, 2013 with State Intellectual Property Office of the P.R. China (SIPO), all of which are fully incorporated herein by reference.

### FIELD OF THE PRESENT TEACHING

The disclosure generally relates to the field of navigation technology, and specifically, the disclosure relates to method and receiver for determining a system time of a navigation system.

### BACKGROUND

At present time, there are four sets of satellite navigation systems in the world: BeiDou (Compass) satellite navigation system, Global Positioning System (GPS), Global Navigation Satellite System (GLONASS) satellite navigation system, and Galileo satellite navigation system developed by China, United States, Russia, and Europe, respectively. The BeiDou satellite navigation system is self-developed by China and can work independently from other satellite navigation systems.

Conventionally, a receiver of a navigation system receives satellite information. Based on the satellite information, the receiver can calculate user information related to the user's position, velocity, and obtain accurate time information based on a calculated system time of the navigation system. The system time of the navigation system is highly accurate and usually carried by an impulse signal, Pulse-Per-Second (PPS). The accuracy of detected PPS at a receiver has become an important measure of the receiver's performance. The accuracy is closely related to the receiver's tracking performance and positioning performance with respect to a satellite signal.

### SUMMARY

In accordance with an embodiment of the present teaching, a receiver and methods for improving accuracy of the system time PPS of the navigation system are disclosed.

In one embodiment, the receiver comprises: a calculation module, configured for receiving satellite information, analyzing pseudorange information included in the satellite information screening and selecting one or more satellites for positioning, calculating position and velocity of the receiver based on the selected one or more satellites, determining system time of the navigation system based on processes of clock bias and timing variation rate of the clock, and outputting the PPS associated with the navigation system time.

In another embodiment, a method for improving accuracy of the system time PPS of the navigation system is disclosed. The method comprises the following. Satellite information is received from satellites. The satellites' pseudorange information included in the satellite information is analyzed. The satellites are screened to select one or more satellites for positioning. Based on the selected one or more satellites, position and velocity of the receiver are calculated. The system time of the navigation system is determined based on processes of clock bias and timing variation rate of the clock, so that the PPS associated with the navigation system is generated and output.

The receiver and method according to various embodiments of the present teaching can provide a more accurate estimate of the navigation system time, based on calculations involving clock bias and timing variation rate of the clock, so that accuracy of the system navigation time PPS can be improved.

### BRIEF DESCRIPTION OF THE DRAWINGS

Features and benefits of embodiments of the claimed subject matter grill become apparent as the following detailed description proceeds, and upon reference to the drawings, wherein like numerals depict like parts. These exemplary embodiments are described in detail with reference to the drawings. These embodiments are non-limiting exemplary embodiments in which like reference numerals represent similar structures throughout the several views of the drawings.

FIG. 1 is a block diagram illustrating an exemplary receiver, in accordance with one embodiment of the present teaching;

FIG. 2 is a block diagram illustrating an exemplary calculation module, in accordance with one embodiment of the present teaching;

FIG. 3 is a flowchart illustrating an exemplary process performed by a calculation module, in accordance with one embodiment of the present teaching;

FIG. 4 is a flowchart illustrating a portion of an exemplary process performed by a calculation module, in accordance with one embodiment of the present teaching;

FIG. 5 is a flowchart illustrating a portion of another exemplary process performed by a calculation module, in accordance with one embodiment of the present teaching; and

FIG. 6 is a flowchart illustrating a portion of yet another exemplary process performed by a calculation module, in accordance with one embodiment of the present teaching.

### DETAILED DESCRIPTION

Reference will now be made in detail to the embodiments of the present teaching. While the present teaching will be described in conjunction with these embodiments, it will be understood that they are not intended to limit the present teaching to these embodiments. On the contrary, the present teaching is intended to cover alternatives, modifications and equivalents, which may be included within the spirit and scope of the present teaching as defined by the appended claims.

Furthermore, in the following detailed description of the present teaching, numerous specific details are set forth in order to provide a thorough understanding of the present teaching. However, it will be recognized by one of ordinary skill in the art that the present teaching may be practiced without these specific details. In other instances, well known methods, procedures, components, and circuits have not been described in detail as not to unnecessarily obscure aspects of the present teaching.

An accuracy of the system navigation time PPS is related to error of the local clock frequency f and error of the local clock counts. The error of the local clock frequency f may be caused by errors of the local clock bias tᵤ and the timing variation rate (or frequency drift) of the local clock \dot{t}ᵤ. In other words, to improve the accuracy of the PPS, one may reduce the error of the local clock bias tᵤ, the error of the timing variation rate of the local clock \dot{t}ᵤ, or the error of the local clock counts. The present teaching mainly focuses on reductions of the error of the local clock bias tᵤ and the error of the timing variation rate of the local clock \dot{t}ᵤ to achieve improved accuracy of the PPS. For simplicity, in the following description, local clock bias tᵤ is referred to as clock bias tᵤ, the timing variation rate (or frequency drift) of the local clock \dot{t}ᵤ is referred to as clock drift \dot{t}ᵤ, and the local clock frequency f is referred to as clock frequency f.

As the clock bias tᵤ is the difference between the local time of the receiver and the system time of the navigation system, the navigation system time can be determined by compensating the local time of the receiver according to the clock bias tᵤ. The determined navigation system time may be output via a PPS directly. The accuracy of the clock bias tᵤ is related to tracking quality of satellites in the navigation system. The clock bias tᵤ is conventionally calculated based on four or more satellites' pseudorange information. Therefore, errors of the pseudorange directly affect the accuracy of the clock bias tᵤ.

In addition, an error of a positioning result may also be caused by errors in the ionospheric and tropospheric regions, and/or positioning methods or strategies at the receiver itself. All of these factors affect the accuracy of the clock bias tᵤ. At the time of positioning, the clock frequency f=f₀·(1+\dot{t}ᵤ), wherein f₀ is the nominal frequency of the receiver. Thus, increasing the accuracy of the clock drift \dot{t}ᵤ can reduce error of the clock frequency f, thereby enhancing the accuracy of the PPS. The present teaching aims at improving performance respectively for each of the several major error sources of the PSS as mentioned above, thereby improving the accuracy of PPS.

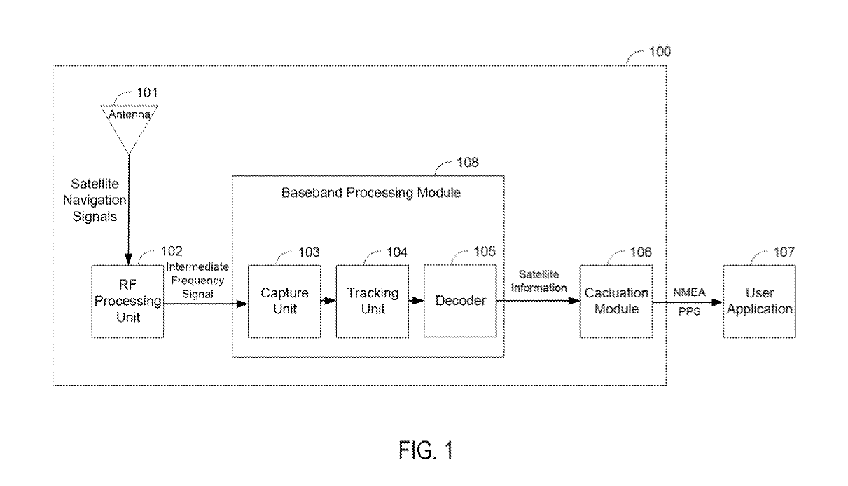

FIG. 1 is a block diagram illustrating an exemplary receiver, in accordance with one embodiment of the present teaching. As shown in FIG. 1, the receiver 100 in this example includes an antenna 101, an RF (Radio frequency) processing unit 102, a baseband processing module 108, and a calculation module 106.

In this example, the antenna 101 receives satellite signals from a plurality of navigation satellites in a satellite navigation system. The RF processing unit 102 converts the received signal into an intermediate frequency signal that the baseband processing module 108 may process. The baseband processing module 108 further includes a capture unit 103, a tracking unit 104, and a decoder 105. The baseband processing module 108 receives an intermediate frequency signal indicating the satellite navigation signals, and assigns resources to the satellite based on factors including e.g. the satellite's visibility, performance, its environment, etc. The assigned resources include hardware resources like capture channel and tracking channels, as well as software resources like resources of a CPU system. The capture unit 103 and the tracking unit 104 captures and tracks respectively the satellites to which resources have been assigned, and generate navigation messages each of which corresponding to a respective positioning satellite, according to the captured and tracked satellite information from the respective positioning satellite. The decoder 105 receives the navigation message and decodes the navigation message to obtain satellite information including e.g. pseudorange, coordinate information, speed information, frequency information, etc.

It should be noted that the satellite navigation signals may be received from a plurality of navigation systems. Due to the different modulation methods and/or frequencies among most navigation systems, navigation messages of the navigation systems have different formats. Therefore, according to a category of the navigation system supported by the receiver, the receiver can be designed selectively to have a different antenna, a different RF signal processing unit, and/or a different baseband processing module. In one embodiment, according to different navigation systems (e.g., BD and GPS satellite navigation systems), each of the receiver antenna 101, the RF processing unit 102 and the baseband processing module 108 is designed to have a different hardware configuration to receive and process satellite navigation signals respectively from different navigation systems. In another embodiment, according to different navigation systems (e.g., Glonass and Galileo satellite navigation systems), each of the receiver antenna 101, the RF processing unit 102 and the baseband processing module 108 has the same hardware configuration but can be equipped with different software dealing with different functions related to navigation. In this situation, the receiver can simultaneously receive and process satellite navigation signals from different satellite navigation systems.

The calculation module 106 receives satellite information including e.g. pseudorange, coordinate information, speed information, frequency information, etc, to calculate the location information and/or the speed/velocity information of the receiver 100. The calculation module 106 can also simultaneously calculate the clock bias tᵤ between the local time of the receiver 100 and the system time of the navigation system, and simultaneously calculate the clock drift \dot{t}ᵤ. After the calculating module 106 calculates the location information and speed information of the receiver 100, the calculating module 106 converts the information into a standard National Marine Electronics Association (NMEA) signal and transmits the signal to a user application 107. Thus, it is convenient for a user to accesses and/or uses the position information and speed information of the receiver 100. At the same time, the calculation module 106 can also achieve a more accurate navigation system time and output the navigation system time via PPS. The navigation system time can be determined based on the calculated clock bias tᵤ and the calculated clock drift \dot{t}ᵤ. While the present teaching mainly utilizes single navigation systems as examples to describe the calculation of the clock bias tᵤ and the clock drift \dot{t}ᵤ, it can be understood by one skilled in the art that the methods disclosed in the present teaching are equally applicable to multi-navigation systems.

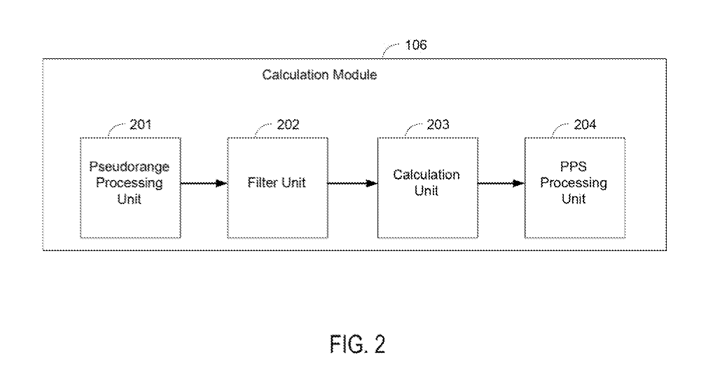

FIG. 2 is a block diagram illustrating an exemplary calculation module 106, in accordance with one embodiment of the present teaching. In one embodiment, this calculation module 106 is the calculation module 106 shown in FIG. 1. As shown in FIG. 2, the calculation module 106 comprises a pseudorange processing unit 201, a filter unit 202, a calculation unit 203, and a PPS processing unit 204.

In this example, the pseudorange processing unit 201 utilizes Carrier-Smoothed-Code Processing (CSC) to improve accuracy of the satellite pseudorange. An equation for the receiver's position measurement may be the following:

ρⱼ=\sqrt{(xⱼ−xᵤ)²+(yⱼ−yᵤ)²+(zⱼ−zᵤ)²}+c·tᵤ+Iono+Tropo+υ_{ρ} (1)

wherein, ρⱼ represents pseudorange between the j-th satellite to the receiver 100 measured through some codes; (xⱼ, yⱼ, zⱼ) represents position of the j-th satellite; (xᵤ, yᵤ, zᵤ) represents location of the receiver 100; tᵤ represents clock bias between the receiver and the navigation system; c represents the speed of light; Iono represents the ionospheric delay; Tropo represents the tropospheric delay; υ_{ρ} represents measurement error of pseudorange, which includes errors caused by multi-path, interference, etc.

Based on equation (1), the accuracy of satellite pseudorange is one of the key factors affecting the accuracy of the clock bias. The position of the receiver and the clock bias tᵤ can be calculated based on four equations associated with satellite pseudorange measurements. When satellite pseudorange measurement has a relative large error, there is a large error in clock bias tᵤ measurement as well. Great multipath error in code observations may be smoothed based on phase observations that have smaller multipath error, e.g., via a Hatch filter (not shown in FIG. 2). Thus, multipath error in code observations may be substantially weakened. An equation for the receiver's carrier phase observation may be the following:

φⱼ=\sqrt{(xⱼ−xᵤ)²+(yⱼ−yᵤ)²+(zⱼ−zᵤ)²}+c·tᵤ−Iono+Tropo+λ·N+υ_{Φ} (2)

wherein, Φⱼ represents carrier phase of the j-th satellite; λ represents the carrier wavelength; N represents the number of cycles of the carrier phase, which contains a value less than the entire cycle; υ_{Φ} represents error of the carrier phase measurement. Carrier phase measurement represents a phase difference between the received satellite carrier signal and the reference carrier signal generated by an oscillator in the receiver. Compared to the pseudorange ρ measured by the pseudo-code, carrier phase Φ is less affected by the multipath or interference. Therefore, the carrier phase Φ can be utilized to perform smoothing via CSC.

Specifically, a Hatch filter (not shown in FIG. 2) utilizes a relationship between the pseudorange measurement equation (1) and the carrier phase observation equation (2) to obtain a smoothed pseudorange equation as the following:

βⱼ(k)=W·ρⱼ(k)+(1−W)·[βⱼ(k−1)+ΔΦⱼ(k)] (3)

wherein, W represents the weight; k represents the k-th time; βⱼ represents pseudorange of the j-th satellite after smoothing via CSC; ΔΦⱼ denotes the carrier phase increment of the j-th satellite. In one embodiment, the weight W is 0.1. It can be understood by one skilled in the art that the value of the weight may be set according to the actual situation; and the above example cannot be considered as limiting the present teaching. In addition, CSC may have other algorithms and processing methods that are not discussed here for simplicity. The above mentioned CSC processing with respect to pseudorange is an embodiment of the present teaching and cannot be regarded as limiting the present teaching.

Thus, after pseudorange is smoothed by the CSC, the accuracy of satellite pseudorange is improved, while the accuracy of the positioning is improved as well. The pseudorange processing unit 201 performs CSC smoothing on pseudorange to get more accurate satellite pseudorange values. In one embodiment, based on pseudorange smoothed by the CSC, the clock bias tᵤ can be calculated by solving simultaneous equations mentioned above directly. The clock bias tᵤ calculated in this manner is more accurate was compared to that calculated in a traditional method. Thus, the accuracy of the clock bias tᵤ is improved indirectly. The screening unit 202 is configured for screening and filtering the captured and tracked satellites, mainly based on strength, elevation, satellite tracking quality, type of the satellite, etc, in addition to the overall environment of satellite signals. The screening unit 202 also calculates position and velocity of the receiver 100 based on the filtered or selected specific satellites. The specific methods of screening and filtering satellites are well known to one skilled in the art, and are thus not mentioned here for simplicity.

The filter unit 202 is configured to determine one or more satellites for calculation. The calculation unit 203 obtains calculated position and velocity of the receiver 100, based on the pseudorange values obtained by the pseudorange processing unit 201 corresponding to the one or more satellites, and the satellites' frequency information. In one embodiment, GP1˜GP4 are four selected GPS satellites after filtering satellites in a GPS system, with position coordinates (x₁, y₁, z₁)˜(x₄, y₄, z₄), wherein the position coordinates of the receiver is (xᵤ, yᵤ, zᵤ). Four equations can be obtained based on the positions and pseudoranges of the four GPS satellites. The position coordinates (xᵤ, yᵤ, zᵤ) and the clock bias tᵤ associated with the receiver 100 can be obtained by solving the four equations. In addition, the velocity and the clock drift \dot{t}ᵤ associated with the receiver 100 can also be calculated, based on technique known to one skilled in the art, which is not described here in detail.

After the calculation unit 203 calculates the position and velocity of the receiver 100, the calculation unit 203 can also achieve the clock bias tᵤ and the clock drift \dot{t}ᵤ, based on CSC smoothed pseudorange. The navigation system time can be calculated directly based on the clock bias tᵤ and the clock drift \dot{t}ᵤ calculated in this manner. In one embodiment, in addition to the above manner, the clock bias tᵤ and the clock drift \dot{t}ᵤ can be calculated through the PPS processing unit 204, to obtain a more accurate navigation system time. The process for calculating the clock bias tᵤ and the clock drift \dot{t}ᵤ will be described in detail in the following embodiments.

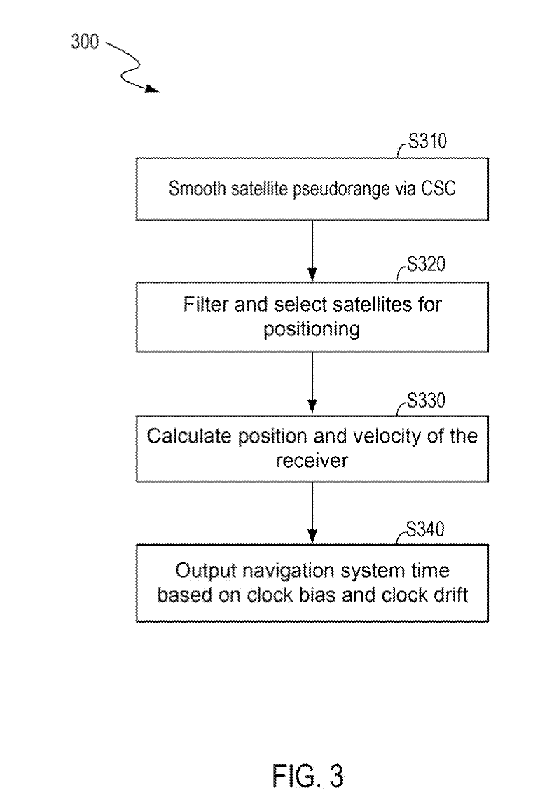

FIG. 3 is a flowchart illustrating an exemplary process 300 for calculating the clock bias tᵤ and the clock drift \dot{t}ᵤ performed by a calculation module 106, e.g. the calculation module 106 shown in FIG. 1, in accordance with one embodiment of the present teaching. The FIG. 3 will be described in conjunction with FIG. 2. As shown in FIG. 3, the exemplary process 300 in this embodiment comprises the following.

At S310, satellite information about pseudorange and frequency is received, a more accurate value of pseudorange is obtained by performing CSC smoothing on the received pseudorange, and the process goes to S320.

At S320, the satellite receiver screens and filters the tracked and captured satellites, and the process does to S330.

At S330, based on information about the pseudorange and frequency of the filtered satellites, position and velocity of the receiver are calculated, and the process goes to S340.

At S340, clock bias tᵤ and clock drift \dot{t}ᵤ are analyzed to calculate the navigation system time, so that the navigation system time can be output via PPS.

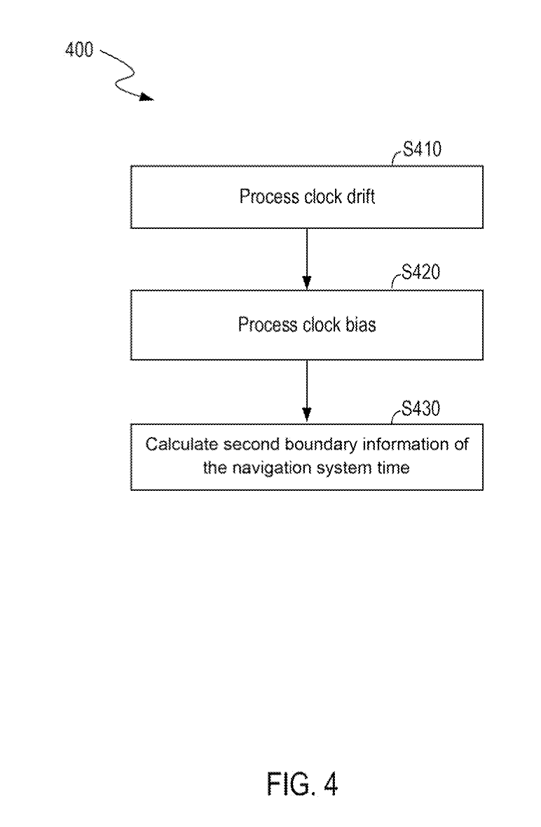

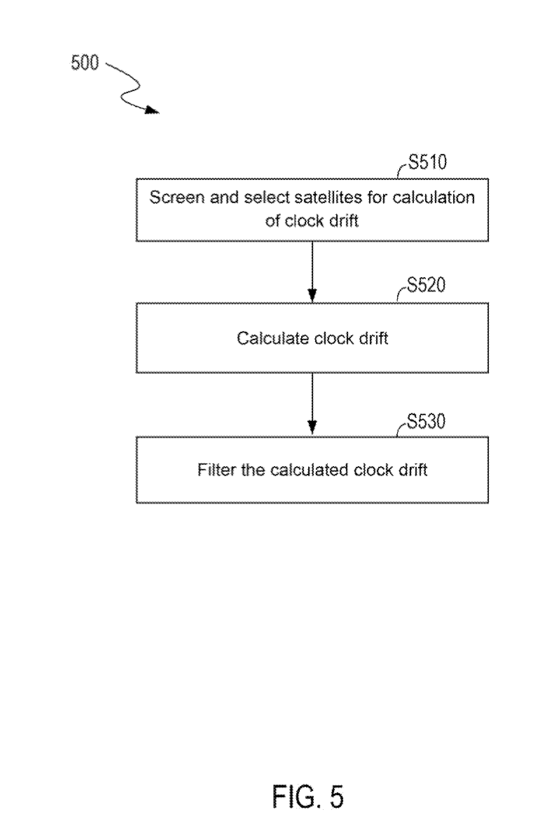

The process at S340 may be accomplished through S410˜S430 as shown in FIG. 4. As shown in FIG. 4, the clock drift \dot{t}ᵤ is first analyzed at S410. The process at S410 may be accomplished through S510˜S530 as shown in FIG. 5.

As shown in FIG. 5, satellites are screened and selected for calculation of clock drift \dot{t}ᵤ at S510. The strength of the satellite signal may be utilized as one of the indicators for the selection in practice, because the strength of the acquired satellite signal affects the accuracy of the clock drift \dot{t}ᵤ. In one embodiment, average signal strength is first determined by averaging strength of all captured satellite signals. If a signal from a satellite is higher than the average signal strength, the satellite is selected. Otherwise, the satellite is not selected. It can be understood by one skilled in the art that the methods for screening satellites are well known. The above mentioned method based on strength is one of the well-known screening methods, and cannot be considered as limiting the present teaching.

At S520, the clock drift \dot{t}ᵤ is calculated. Since frequency drift such as the clock drift \dot{t}ᵤ is caused by the device (e.g. the receiver) itself, the value of the clock drift \dot{t}ᵤ may be obtained based on the speed information. In one embodiment, when a relatively accurate speed is known, the clock drift \dot{t}ᵤ of the receiver can also be calculated as the following. PPS is typically applied in a static scenario, where the accurate velocity or speed of the receiver is 0. In other scenarios with high precision requirements, an accurate speed of the receiver can be obtained via some speed-measurement device. Based on the satellite speed, one can achieve a more accurate calculation of the frequency from the satellite to the receiver:

$${f}_{Rj} = {f}_{Tj} ( 1 - \frac{( {v}_{1} - \hat{u} ) \cdot {a}_{1}}{c} ) \qquad ( 4 )$$

wherein, f_{Tj} represents the frequency of the satellite transmitted signal; aⱼ represents a unit vector along a straight line directed from the receiver to the satellite; vⱼ represents speed of the satellite; \dot{u} represents speed of the receiver.

The frequency fⱼ measured by the receiver contains a clock drift \dot{t}ᵤ, that is:

f_{Rj}=fⱼ(1−tᵤ) (5)

It can be achieved based on equation (5):

$${t}_{u} = \frac{{f}_{j} - {f}_{Rj}}{{f}_{j}} \qquad ( 6 )$$

While the equation (6) represents a clock drift \dot{t}ᵤ calculated based on a single satellite, an average clock drift \dot{t}ᵤ in practice may be calculated based on multiple satellites that are selected to good quality of satellite tracking, which is calculated using the following:

$${t}_{u} = \frac{1}{N} {\sum }_{j = 0}^{N} \frac{{f}_{j} - {f}_{Rj}}{{f}_{j}} \qquad ( 7 )$$

wherein, j represents the j-th satellite; N represents the number of satellites involved in the calculation. Thus, the accuracy of the clock drift calculation can be improved by the above method. In one example, the clock drift calculated by this method can be directly used to calculate the navigation system time. In another example, the clock drift calculated by this method can be filtered to obtain a more accurate clock drift.

At S530, the calculated clock drift is filtered. Since the local clock drift is determined by device characteristics, the clock drift \dot{t}ᵤ can be filtered or fit in real-time, based on different device characteristics. A common moving average filter can be used:

$${t}_{u}^{∼} ( k ) = \frac{1}{M} {\sum }_{l = k - M}^{k} {t}_{u} ( i ) \qquad ( 8 )$$

wherein, i represents the i-th time point; tᵤ(i) represents the clock drift calculated in real-time at the i-th time point; M represents the length of the sliding time window, whose length may be different based on different device characteristics.

When the clock drift is filtered, the clock drift tᵤ(i) in the equation (8) may be calculated by the method at S520, or by conventional methods. In one embodiment, the clock drift tᵤ(i) in the equation (8) is calculated by the method at S520 to achieve a higher accuracy clock drift.

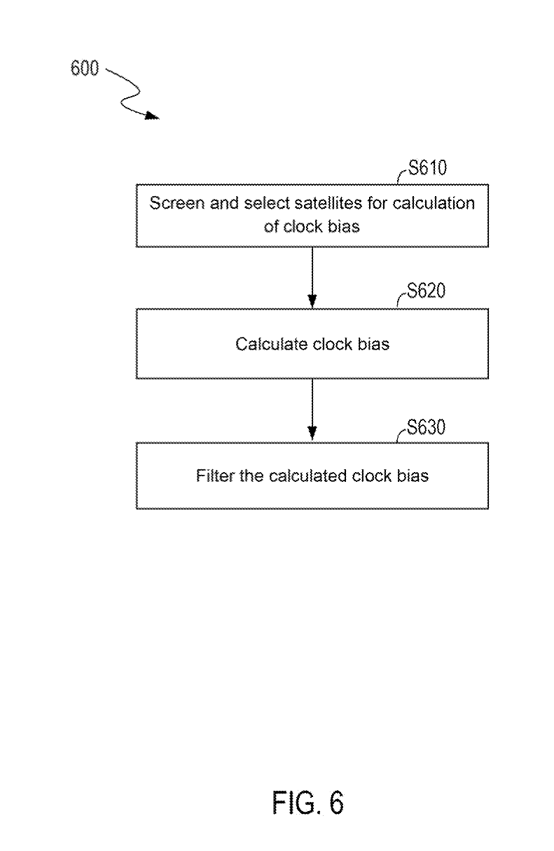

At S420, the clock bias tᵤ is analyzed. As discussed above, a more accurate pseudorange measurement can be obtained by a smooth via CSC, compared to a traditional method. Besides increasing the accuracy of the pseudorange, an accuracy of the clock bias tᵤ can also be improved by the following method shown in FIG. 6. Specifically, the processing at S420 can be accomplished through S610˜S630 as shown in FIG. 6.

As shown in FIG. 6, at S610, satellites are screened and selected to participate in the clock bias calculation. Here, the satellites are screened and selected based on pseudorange quality, signal strength, satellite elevation, loop tracking quality, etc. At S620, the clock bias is calculated. After determining the satellites for clock bias calculation, the estimate of the clock bias can be expressed as the following:

$$\begin{matrix}{\hat{t}}_{u} ( k ) = \frac{1}{Φ N} {\sum }_{l = 1}^{N} ( {ρ}_{l} ( k ) - {D}_{l} ( k ) - Iono - Tropo ) & ( 9 ) \\ {D}_{l} ( k ) = \sqrt{{( {x}_{l} ( k ) - {x}_{u} ( k ) )}^{2} + {( {y}_{l} ( k ) - {y}_{u} ( k ) )}^{2} + {( {x}_{l} ( k ) - {z}_{u} ( k ) )}^{2}} & ( 10 )\end{matrix}$$

wherein, ρᵢ(k) represents the pseudorange of the i-th satellite at the k-th time point; Dᵢ(k) represents the actual distance between the i-th satellite and the receiver at the k-th time point; Iono represents the ionospheric delay; and Tropo represents the tropospheric delay. The detailed calculation for Dᵢ(k) is well known to one skilled in the art, and is thus not discussed here for simplicity. In an embodiment of the present invention, the Dᵢ(k) is calculated by considering the effect of the Earth's self-rotation.

In one embodiment, the receiver is stationary, and the static position of the receiver can be modeled with a static model to improve the accuracy of the static position of the receiver, thereby improving the accuracy of Dᵢ(k). The method in the present teaching to obtain Dᵢ(k) also includes a support for an input from external indicating the exact position of the receiver. In addition, if ρᵢ(k) in equation (9) is replaced by a CSC smoothed pseudorange βⱼ(k), the accuracy of the clock bias can be further improved. Like the clock drift, the clock bias calculated based on equation (9) can be directly used to calculate the navigation system time; or, the calculated clock bias can be filtered to obtain a more accurate clock bias.

At S630, the clock bias is filtered. According to various embodiments of the present teaching, the filter can be a weighted sum. The estimate of the clock bias based on this filtering method may be expressed as:

\hat{t}ᵤ(k)=W·tᵤ(k)+(1−W)·(\hat{tᵤ}(k−1)·ΔT+\hat{t}ᵤ(k−1)) (11)

wherein, [symbol] represents the estimated value of the clock drift, which can be a value from S530 in FIG. 5 after filtering; k represents the k-th time point; ΔT represents the time difference between the (k−1)-th time point and the k-th time point; W is the weight. The filtered clock bias can be calculated by a traditional method, or calculated after the CSC smoothing, or calculated following the equation (9). Filtering the clock bias may also improve the accuracy of the clock bias.

At S430, the boundary information (for each second) of the navigation system time PPS is calculated. As mentioned above, the navigation system time can be obtained by compensating the local clock of the receiver based on the determined clock bias and clock drift. In one embodiment, the local time at the receiver is assumed to be T′ᵣ, where the local time clock count is Nᵣ, the clock frequency is f, and the navigation system time Tᵣ. Then, there is a relationship:

Tᵣ=T′ᵣ−tᵤ (12)

Because f=f₀·(1+tᵤ), f₀ is the receiver's nominal frequency, the next second boundary time for the navigation system time PPS is:

Tₚₚₛ=floor(Tᵣ)+1 (13)

wherein, floor(Tᵣ) represents a greatest integer less than or equal to Tᵣ. The local clock count corresponding to next second boundary of the PPS is:

Nₚₚₛ=Nᵣ+(Tₚₚₛ−Tᵣ)·f (14)

When the local clock count reaches Nₚₚₛ, the receiver can determine and output the second boundary, i.e. outputting the PPS, according to the configured format.

It should be noted that the above methods of calculating the clock bias and the clock drift are not in conflict with each other. Each of the above mentioned methods for improving the accuracy of the clock bias or the clock drift can be applied independently, or may be superimposed together. In an exemplary test, a superimposition of the above mentioned methods can achieve best performance.

Further, embodiments of the present teaching are applicable to not only dual-mode receiver but also single-mode receiver. Embodiments of the present teaching are applicable to not only GPS receivers, BD receivers, but also GLONASS receivers and Galileo receivers.

Ordinary persons having skills in the art can understand that the implementation of all or part of the processes in the above-described embodiments can be performed by a computer program instructing relevant hardware. The program may be stored in a computer readable storage medium, the program when executed, may include methods as discussed in the above embodiments. Among them, the storage medium may be a magnetic disk, optical disk, memory read-only memory (ROM) or random access memory (RAM) and so on.

While the foregoing description and drawings represent embodiments of the present teaching, it will be understood that various additions, modifications and substitutions may be made therein without departing from the spirit and scope of the principles of the present teaching as defined in the accompanying claims. One skilled in the art will appreciate that the teaching may be used with many modifications of form, structure, arrangement, proportions, materials, elements, and components and otherwise, used in the practice of the teaching, which are particularly adapted to specific environments and operative requirements without departing from the principles of the present teaching. The presently disclosed embodiments are therefore to be considered in all respects as illustrative and not restrictive, the scope of the teaching being indicated by the appended claims and their legal equivalents, and not limited to the foregoing description.

We claim:

1. A receiver for determining system time of a navigation system, comprising:
a baseband processing module configured for obtaining satellite information from the navigation system; and
a calculation module configured for:
estimating a pseudorange based on the satellite information;
smoothing the pseudorange via a code;
calculating clock bias and clock drift based on the smoothed pseudorange; and
determining system time of the navigation system based on the calculated clock bias and clock drift.

2. The receiver of claim 1, wherein the calculation module comprises:
a pseudorange processing unit configured for smoothing the pseudorange included in the satellite information;
a filter unit configured for screening captured satellites in the navigation system to select one or more satellites for positioning;
a calculation unit configured for calculating position and velocity of the receiver based on one or more smoothed pseudoranges corresponding to the one or more satellites; and
a PPS processing unit configured for calculating clock bias and clock drift based on the one or more smoothed pseudoranges and determining system time of the navigation system based on the calculated clock bias and clock drift.

3. The receiver of claim 1, further comprising:
an antenna configured for receiving satellite navigation signals satellites in the navigation system; and
an RF processing unit configured for processing the satellite navigation signals to generate an intermediate frequency signal, wherein the baseband processing module is further configured for allocating resources to at least some of the satellites, tracking the satellites allocated resources to obtain the satellite information, wherein the satellite information comprises at least one of pseudorange, coordinate information, speed information and frequency information.

4. The receiver of claim 1, wherein:
the code is a Carrier-Smoothed-Code (CSC); and
the smoothed pseudorange is calculated as:
\hat{ρ}ᵢ(k)=W·ρᵢ(k)+(1−W)·[\hat{ρ}ᵢ(k−1)+ΔΦⱼ(k)],
wherein W represents a weight; k represents k-th time point; βⱼ represents pseudorange of j-th satellite after smoothing via CSC; ΔΦⱼ denotes carrier phase increment of j-th satellite.

5. The receiver of claim 1, wherein the clock bias is calculated as:
$${\hat{t}}_{u} ( k ) = \frac{1}{Φ N} {\sum }_{l = 1}^{N} ( {ρ}_{l} ( k ) - {D}_{l} ( k ) - Iono - Tropo )$$
$${D}_{l} ( k ) = \sqrt{{( {x}_{l} ( k ) - {x}_{u} ( k ) )}^{2} + {( {y}_{l} ( k ) - {y}_{u} ( k ) )}^{2} + {( {x}_{l} ( k ) - {z}_{u} ( k ) )}^{2}}$$
wherein, ρᵢ(k) represents the pseudorange of i-th satellite at k-th time point; Dᵢ(k) represents actual distance between i-th satellite and the receiver at k-th time point; Iono represents an ionospheric delay; and Tropo represents an tropospheric delay.

6. The receiver of claim 1, wherein the clock drift is calculated as:
$${t}_{u} = \frac{1}{N} {\sum }_{j = 0}^{N} \frac{{f}_{j} - {f}_{Rj}}{{f}_{j}}$$
wherein j represents j-th satellite; N represents number of satellites involved in the calculation.

7. The receiver of claim 1, wherein the clock drift is filtered by:
$${f}_{u}^{∼} ( k ) = \frac{1}{M} {\sum }_{i = k - M}^{k} {t}_{u} ( l )$$
wherein i represents i-th time point; tᵤ(i) represents the clock drift calculated in real-time at i-th time point; M represents length of a sliding time window.

8. The receiver of claim 1, wherein the clock bias is filtered by:
\hat{t}ᵤ(k)=W·tᵤ(k)+(1−W)·(\hat{tᵤ}(k−1)·ΔT+\hat{t}ᵤ(k−1))
wherein \hat{t}\hat{tᵤ} represents an estimated value of the clock drift; k represents k-th time point; ΔT represents a time difference between (k−1)-th time point and k-th time point; W represent a weight.

9. The receiver of claim 2, wherein the PPS processing unit is further configured for:
outputting the navigation system time via an impulse signal Pulse-Per-Second (PPS); and
determining next second boundary time for the navigation system time PPS.

10. A method for determining system time of a navigation system, comprising:
obtaining satellite information from the navigation system;
estimating a pseudorange based on the satellite information;
smoothing the pseudorange via a code;
calculating clock bias and clock drift based on the smoothed pseudorange; and
determining system time of the navigation system based on the calculated clock bias and clock drift.

11. The method of claim 10, further comprises:
screening captured satellites in the navigation system to select one or more satellites for positioning; and
calculating position and velocity of the receiver based on one or ore smoothed pseudoranges corresponding to the one or more satellites.

12. The method of claim 10, further comprising:
receiving satellite navigation signals from satellites in the navigation system;
processing the satellite navigation signals to generate an intermediate frequency signal;
allocating resources to at least some of the satellites; and
tracking the satellites allocated resources to obtain the satellite information, wherein the satellite information comprises at least one of pseudorange, coordinate information, speed information and frequency information.

13. The method of claim 10, wherein:
the code is a Carrier-Smoothed-Code (CSC); and
the smoothed pseudorange is calculated as:
βⱼ(k)=W·ρⱼ(k)+(1−W)·[βⱼ(k−1)+ΔΦⱼ(k)],
wherein W represent weight; k represents k-th time point; βⱼ represents pseudorange of j-th satellite after smoothing via CSC; ΔΦⱼ denotes carrier phase increment of j-th satellite.

14. The method of claim 10, wherein the clock bias is calculated as:
$${\hat{t}}_{u} ( k ) = \frac{1}{Φ N} {\sum }_{l = 1}^{N} ( {ρ}_{l} ( k ) - {D}_{l} ( k ) - Iono - Tropo )$$
$${D}_{l} ( k ) = \sqrt{{( {x}_{l} ( k ) - {x}_{u} ( k ) )}^{2} + {( {y}_{l} ( k ) - {y}_{u} ( k ) )}^{2} + {( {z}_{l} ( k ) - {z}_{u} ( k ) )}^{2}}$$
wherein, ρᵢ(k) represents the pseudorange of i-th satellite at k-th time point; Dᵢ(k) represents actual distance between i-th satellite and the receiver at k-th time point; Iono represents an ionospheric delay; and Tropo represents an tropospheric delay.

15. The method of claim 10 wherein the clock drift is calculated as:
$${t}_{u} = \frac{1}{N} {\sum }_{j = 0}^{N} \frac{{f}_{j} - {f}_{Rj}}{{f}_{j}}$$
wherein j represents j-th satellite; N represents number of satellites involved in the calculation.

16. The method of claim 10, wherein the clock drift is filtered by:
$${f}_{u}^{∼} ( k ) = \frac{1}{M} {\sum }_{i = k - M}^{k} {t}_{u} ( l )$$
wherein i represents i-th time point; tᵤ(i) represents the clock drift calculated in real-time at i-th time point; M represents length of a sliding time window.

17. The method of claim 10, wherein the clock bias is filtered by:
\hat{t}ᵤ(k)=W·tᵤ(k)+(1−W)·( [symbol] (k−1)·ΔT+\hat{t}ᵤ(k−1))
wherein [symbol] represents an estimated value of the clock drift; k represent k-th time point; ΔT represents a time difference between (k−1)-th time point and k-th time point; W represent a weight.

18. The method of claim 11, further comprising:
outputting the navigation system time via an impulse signal Pulse-Per-Second (PPS); and
determining next second boundary time for the navigation system time PPS.

19. A machine-readable tangible and non-transitory medium having information for determining system time of a navigation system, wherein the information, when read by the machine, causes the machine to perform the following:
obtaining satellite information from the navigation system;
estimating a pseudorange based on the satellite information;
smoothing the pseudorange via a code;
calculating clock bias and clock drift based on the smoothed pseudorange; and
determining system time of the navigation system based on the calculated clock bias and clock drift.
